(19) United States
(12) Patent Application Publication
(10) Pub. No.: US 2025/0086496 A1
(43) Pub. Date: Mar. 13, 2025

(54) METHOD AND APPARATUS FOR AUGMENTING KNOWLEDGE USING INFORMATION OF FEDERATED LEARNING

(71) Applicant: FOUNDATION OF SOONGSIL UNIVERSITY-INDUSTRY COOPERATION, Seoul (KR)

(72) Inventors: Min Hae KWON, Seoul (KR); Mi Ru KIM, Seoul (KR); Hee Won PARK, Seoul (KR)

(73) Assignee: FOUNDATION OF SOONGSIL UNIVERSITY-INDUSTRY COOPERATION, Seoul (KR)

(21) Appl. No.: 18/404,143

(22) Filed: Jan. 4, 2024

(30) Foreign Application Priority Data
Sep. 7, 2023 (KR) 10-2023-0119121

(51) Int. Cl. G06N 20/00

(52) U.S. Cl. CPC G06N 20/00

(57) ABSTRACT

A method and apparatus for augmenting knowledge using federated learning information. An apparatus for augmenting knowledge using federated learning information comprises a transceiver unit that receives local information including a global parameter of a local model, a local latent vector, and a local loss value from each of a plurality of individual devices, a data storage unit that stores the local information, a federated learning execution unit that collects a global parameter of the local model and generates a federated global parameter for a global model, and a large model learning unit that generates a true label approximate value for learning a large model using the local information and the federated global parameter, and learns the large model using a prediction result obtained by inputting the local latent vector into the large model and the true label approximate value.

### CROSS-REFERENCE TO RELATED APPLICATIONS

This application claims the benefit of Korean Application No. 10-2023-0119121, filed Sep. 7, 2023, in the Korean Intellectual Property Office. All disclosures of the document named above are incorporated herein by reference.

### TECHNICAL FIELD

The present invention relates to a method and apparatus for augmenting knowledge using the information on federated learning.

### BACKGROUND ART

Federated learning refers to a method of learning an artificial intelligence model with a set of other local models by sharing only the information of the local model with the server without sharing local data.

A local model can be successfully learned through federated learning in situations where there is not enough local data to learn the model, and it has strengths in terms of data security because local data is not shared with the server.

FIG. 1 is a diagram for explaining a federated learning process according to the prior art.

Referring to FIG. 1, federated learning uses local data to learn a local model, and individual devices transmit local model parameters Wᵢ to the server, and the server collects the local model parameters to generate server global parameters W̅. Afterward, the generated server global parameters W̅ are transmitted to individual devices.

As shown in FIG. 1, federated learning does not share data from individual devices and learns by transmitting only local model parameters to the server, making it possible to learn artificial intelligence models without exposing the private data of individual devices.

However, existing federated learning is unable to generate a model optimized for the data distributions of each individual device.

Accordingly, personalized federated learning was proposed.

FIG. 2 is a diagram for explaining a personalized federated learning process according to the prior art.

Referring to FIG. 2, in personalized federated learning, a global parameter Sᵢ among the local parameters and global parameters of the local model is transmitted to the server, and the server collects the global parameters of the local model to generate a server global parameter S̅. Afterward, the generated server global parameter S̅ is transmitted to individual devices.

In this way, when the characteristics of each local data are different, personalized federated learning learns a global model by sharing only a portion of the parameters of the local model so that the local model can perform well for each local data, and uses the portion that is not shared to personalize the local model and proceeds with learning.

However, in reality, individual devices participating in personalized federated learning are likely to be low-end IoT devices, and as a result, there is a problem of limited performance due to limitations in model capacity that can be computed.

### DISCLOSURE

### Technical Issues

In order to solve the problems of the prior art described above, the present invention seeks to propose a knowledge-augmenting method and apparatus using federated learning information that augments knowledge with those from local small models of individual devices, including low-end devices, to large models located on servers.

### Technical Solution

In order to achieve the above object, according to an embodiment of the present invention, an apparatus for augmenting knowledge using federated learning information comprises a transceiver unit that receives local information including a global parameter of a local model, a local latent vector, and a local loss value from each of a plurality of individual devices; a data storage unit that stores the local information; a federated learning execution unit that collects a global parameter of the local model and generates a federated global parameter for a global model; and a large model learning unit that generates a true label approximate value for learning a large model using the local information and the federated global parameter, and learns the large model using a prediction result obtained by inputting the local latent vector into the large model and the true label approximate value.

Each of the plurality of individual devices may use local data to learn a local model composed of a local parameter and a global parameter, and the local information may comprise a global parameter of a local model, in which the learning was performed, a local latent vector obtained by inputting the local data into a local parameter of the local model, and a local loss value obtained by inputting the local latent vector into the global parameter of the local model.

The large model learning unit may comprise a true label approximate value generation unit that generates the true label approximate value; and a learning execution unit that learns the large model using the generated true label approximate value and a preset loss function.

The true label approximate value generation unit may generate the true label approximate value through a softmax temperature-based reverse inference process.

The true label approximate value generation unit may generate a true label approximate value distribution by applying a softmax temperature determined based on the local loss value to a prediction probability result obtained by inputting the local latent vector into the global model.

The true label approximate value generation unit may determine the softmax temperature through a relative scale that allows a lot of learning using local information of an individual device that is relatively good at predicting in a current communication round and an absolute scale that determines an amount of learning using local information of each individual device

The learning execution unit may perform learning of the large model using a distance-based loss function to follow the true label approximate value distribution.

The true label approximate value generation unit may generate the true label approximate value using a cross-entropy loss function.

The true label approximate value generation unit may generate the true label approximate value using a loss value set for a prediction result obtained by inputting the local latent vector into the global model.

The true label approximate value generation unit may reversely infer an element with the closest distance to a true label probability value as a true label approximate value by using elements included in the loss value set and the true label probability value calculated using the local loss value.

The large model learning unit may learn the large model using local information received in a current communication round, and further learn the large model by randomly sampling a portion of the local information stored in the data storage unit.

According to another aspect of the present invention, a system for augmenting knowledge using federated learning information comprises a plurality of individual devices that store local data for learning a local model composed of a local parameter and a global parameter, learn the local model using the local data, and extract a portion of information about the learned local model as local information; and a server that receives the extracted local information from each of the plurality of individual devices, stores the local information, generates a federated global parameter for a global model using the local information, uses the local information and the federated global parameter to generate a true label approximate value for learning a large model, and learns the large model using a prediction result obtained by inputting the local latent vector into the large model and the true label approximate value.

According to another aspect of the present invention, a method for augmenting knowledge using federated learning information in an apparatus including a processor and a memory comprises receiving local information including a global parameter of a local model, a local latent vector, and a local loss value from each of a plurality of individual devices; storing the local information; collecting a global parameter of the local model and generating a federated global parameter for a global model using the collected global parameter; and generating a true label approximate value for learning a large model using the local information, and learning the large model using a prediction result obtained by inputting the local latent vector into the large model and the true label approximate value.

According to another aspect of the present invention, a computer program stored in a computer-readable recording medium that performs the above method is provided.

### Advantageous Effects

According to the present invention, since only indirect information of individual devices is used to learn a large model, exposure of private data of individual devices is prevented, and since the server database is used to secure more data, sufficient data to train a large model can be secured.

### BRIEF DESCRIPTION OF DRAWINGS

These and/or other aspects will become apparent and more readily appreciated from the following description of the embodiments, taken in conjunction with the accompanying drawings in which:

FIG. 1 is a diagram for explaining a federated learning process according to the prior art;

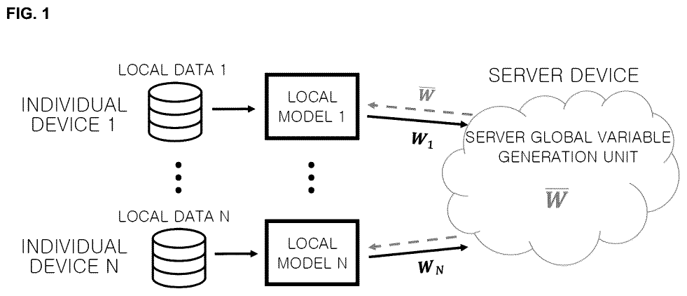

FIG. 2 is a diagram for explaining a personalized federated learning process according to the prior art;

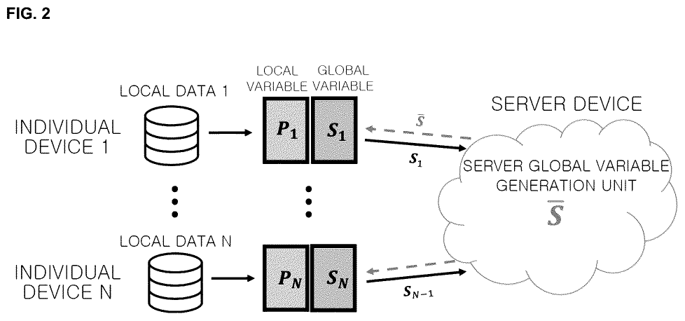

FIG. 3 is a diagram showing the configuration of a knowledge augmenting system using federated learning information according to this embodiment;

FIG. 4 is a diagram showing the detailed configuration of an individual device according to this embodiment;

FIG. 5 is a diagram illustrating a local model learning process according to this embodiment;

FIG. 6 is a diagram showing the detailed configuration of a server according to this embodiment;

FIG. 7 is a diagram showing the detailed configuration of the large model learning unit according to this embodiment;

FIG. 8 is a diagram showing true label data samples and prediction data samples;

FIG. 9 is a diagram showing softening and hardening in the softmax temperature-based true label reverse inference method;

FIG. 10 is a diagram to explain the relative scale in the process using softmax temperature;

FIG. 11 is a diagram to explain the absolute scale in the process using softmax temperature; and

FIG. 12 is a diagram to explain the cross entropy-based true label reverse inference process according to this embodiment.

### DETAILED DESCRIPTION OF EMBODIMENTS

Since the present invention can make various changes and have various embodiments, specific embodiments will be illustrated in the drawings and described in detail in the detailed description. However, this is not intended to limit the present invention to specific embodiments, and should be understood to include all changes, equivalents, and substitutes included in the spirit and technical scope of the present invention.

The terms used herein are only used to describe specific embodiments and are not intended to limit the invention. Singular expressions include plural expressions unless the context clearly dictates otherwise. In this specification, terms such as “comprise” or “have” are intended to indicate the presence of features, numbers, steps, operations, components, parts, or combinations thereof described in the specification, but are not intended to exclude in advance the possibility of the existence or addition of one or more other features, numbers, steps, operations, components, parts, or combinations thereof.

In addition, the components of the embodiments described with reference to each drawing are not limited to the corresponding embodiments, and may be implemented to be included in other embodiments within the scope of maintaining the technical spirit of the present invention, and a plurality of embodiments may be re-implemented as a single integrated embodiment even if separate descriptions are omitted.

In addition, when describing with reference to the accompanying drawings, identical or related reference numerals will be assigned to identical components regardless of the reference numerals, and overlapping descriptions thereof will be omitted. In describing the present invention, if it is determined that a detailed description of related known technologies may unnecessarily obscure the gist of the present invention, the detailed description will be omitted.

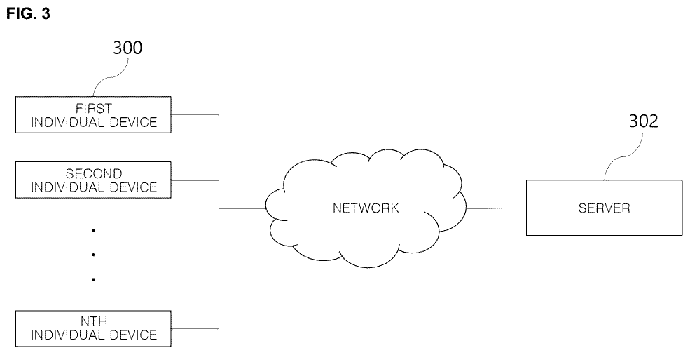

FIG. 3 is a diagram showing the configuration of a knowledge-augmenting system using federated learning information according to this embodiment.

As shown in FIG. 3, the knowledge augmenting system according to this embodiment may include a plurality of individual devices 300 and a server 302 connected to the plurality of individual devices 300 through a network.

Here, the network may include wired or wireless Internet and mobile communication networks.

According to this embodiment, a plurality of individual devices 300 learn a local model using local data, extract some information related to the local model as local information, and transmit it to the server 300.

Here, the local information may include the global parameter of the local model where learning was performed, the local latent vector obtained by inputting local data into the local parameter of the local model, and the local loss value obtained by inputting the local latent vector into the global parameter of the local model.

According to this embodiment, in order to learn a large model in the server 300, indirect information of a plurality of individual devices 300 is used to prevent data exposure of individual devices, and sufficient data is secured in the server 300 to increase the large model's learning performance.

Hereinafter, a method for augmenting knowledge using federated learning information according to this embodiment will be described in detail with reference to the drawings.

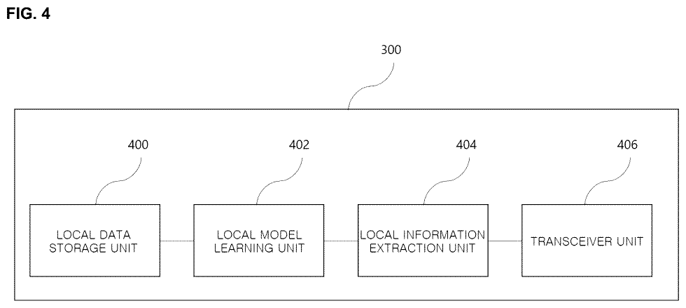

FIG. 4 is a diagram showing the detailed configuration of an individual device according to this embodiment.

As shown in FIG. 4, the individual device 300 according to this embodiment may include a local data storage unit 400, a local model learning unit 402, a local information extraction unit 404, and a transceiver unit 406.

The local data storage unit 400 stores local data for learning the local model, and the local model learning unit 402 uses the local data to learn the local model.

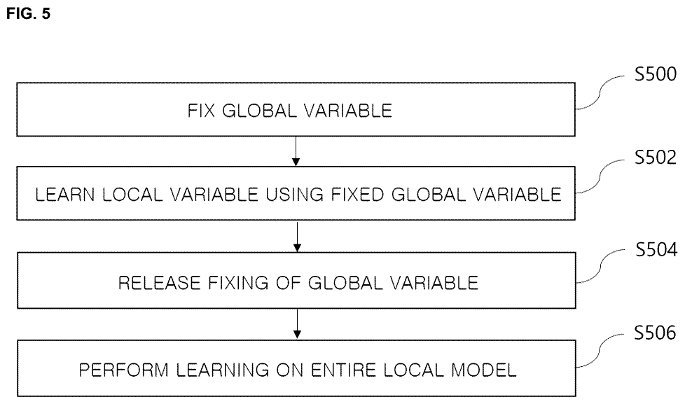

FIG. 5 is a diagram illustrating a local model learning process according to this embodiment.

Referring to FIG. 5, in order to learn a local model composed of local parameters and global parameters, the global parameters are first fixed (step 500), and learning of the local parameters is performed using the fixed global parameters (step 502).

Here, the local parameter is a weight of the local model itself that is not shared with the server 302, and the global parameter is a parameter that performs prediction using the output result of the local parameter as an input and is a parameter shared with the server 302.

After learning of the local parameters is completed, the fixing of the global parameters is released (step 504), and learning of the entire local model is performed (step 506).

Through the above-mentioned fixing of global parameters, the information gap between global parameters and local parameters can be reduced in the local model.

Local model learning of the present invention is not limited to the above-described process, and a local model learning method through various part-sharing federated learning may also be included in the scope of the present invention.

The local information extraction unit 404 extracts local information including global parameters to be shared with the server 302, local latent vectors, and local loss values, and the transceiver unit 406 transmits the extracted local information to the server 302.

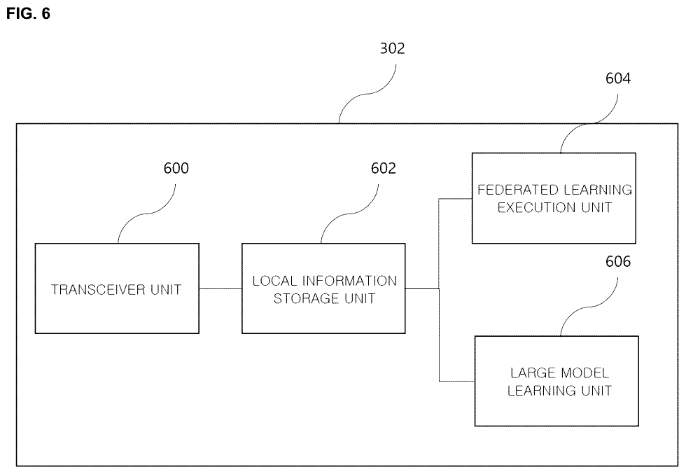

FIG. 6 is a diagram showing the detailed configuration of a server according to this embodiment.

As shown in FIG. 6, the server 302 according to this embodiment may include a transceiver unit 600, a local information storage unit 602, a federated learning execution unit 604, and a large model learning unit 606.

The transceiver unit 600 receives local information from each of the plurality of individual devices 300, and stores it in the local information storage unit 602.

The federated learning execution unit 604 collects global parameters transmitted from a plurality of individual devices 300 and generates federated global parameters of the global model using the collected global parameters.

The federated global parameter of the global model may be generated using global parameters collected from each individual device 300. For example, the federated global parameter may be generated as the average of local parameters.

The federated global parameter is transmitted to a plurality of individual devices 300 through the transceiver unit 600, and the plurality of individual devices 300 update the federated global parameter as a global parameter of their local model.

The large model learning unit 606 learns a large model using local information received from the individual device 300.

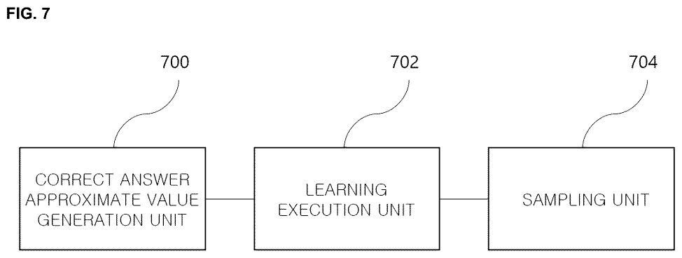

FIG. 7 is a diagram showing the detailed configuration of the large model learning unit according to this embodiment.

As shown in FIG. 7, the large model learning unit 306 according to this embodiment may include a true label approximate value generation unit 700, a learning execution unit 702, and a sampling unit 704.

The true label approximate value generation unit 700 uses a preset algorithm to generate a true label approximate value required for learning a large model.

According to this embodiment, the generation of the true label approximate value can be performed through the true label reverse inference method using softmax temperature or the true label reverse inference method based on cross-entropy loss.

Below, the process of generating a true label approximate value based on softmax temperature and cross-entropy loss is explained in detail through equations, and common parameter definitions are shown in Table 1.

TABLE 1

| Notation | Descript |
|---|---|
| i | Individual device No. |
| Nᵢ | Number of data samples of ith device |
| J | Number of classes to be classified |
| vᵢ = [v_{i,1}, ··· , v_{i,N}_{ₜ}] | Latent vector set of ith device |
| Iᵢ = [l_{i,1}, ··· , l_{i,N}_{ₜ}] | Loss value set of ith device |
| yᵢ = [y_{i,1}, ··· , y_{i,N}_{ₜ}] | Correct answer data set of ith device |
| y_{i,n} = [ψ_{i,n}(1), ··· , ψ_{i,n}(J)] | nth true label data sample of ith device |
| y′ₗ = [y_{i,1}, ··· , y_{i,N}_{ₜ}] | Prediction data set of ith device |
| y′_{i,n} = [ψ′_{i,n}(1), ··· , ψ′_{i,n}(J)] | nth prediction data sample of ith device |
| ŷᵢ = [ŷ_{i,1}, ··· , ŷ_{i,N}_{ₜ}] | Correct answer approximate value set |
| | inferred by server |
| ŷ_{i,n} = [\hat{ψ}_{i,n}(1), ··· , \hat{ψ}_{i,n}(J)] | Correct answer approximate value |
| | sample inferred by server |

First, the true label/prediction data sample is explained.

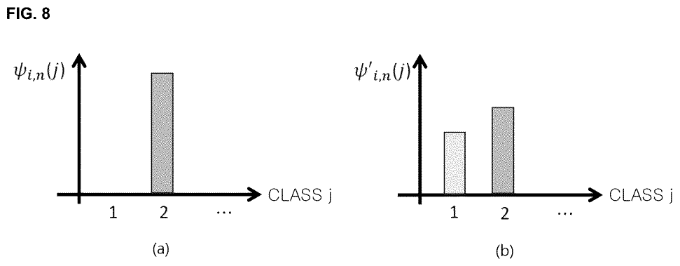

As shown in FIG. 8a, the true label data sample y_{i,n}=[ψ_{i,n}(1), . . . , ψ_{i,n}(J)] has a value of 1 for only one true label class among all classes.

Meanwhile, as shown in FIG. 8b, the prediction data sample y′_{i,n}=[ψ′_{i,n}(1), . . . , ψ′_{i,n}(J)] is a local model prediction result (original prediction probability result) from an individual device and has prediction probability values for multiple classes, and it is ψ′_{i,n}(1)+ . . . +ψ′_{i,n}(J)=1.

The reverse inference method using the softmax temperature (T) is a method of adjusting the probability by weighting the original prediction probability result ψ′_{i,n} as shown in the equation below.

Here, the original prediction probability result is the result output by inputting the local latent vector received from the individual device 300 into the global model (federated global parameter) of the server 302. Since the federated global parameter is shared by the individual device 300, the original prediction probability result from each individual device and the original prediction probability result from the server 302 are the same.

$${\hat{ψ}}_{i , n} ( j ) = \frac{exp ( {ψ}_{i , n}^{′} ( j ) / T )}{{\sum }_{k = 0}^{J} exp ( {ψ}_{i , n}^{′} ( k ) / T )} \qquad [ Equation 1 ]$$

Equation 1 represents the true label approximate value generated by the softmax temperature-based true label reverse inference method in the server.

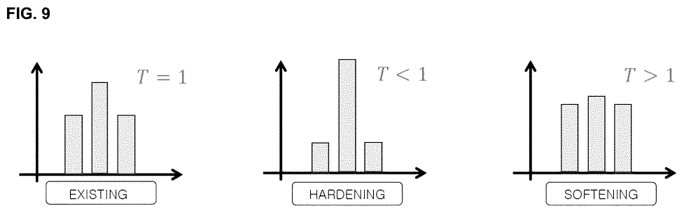

FIG. 9 is a diagram showing softening and hardening in the softmax temperature-based true label reverse inference method.

As shown in FIG. 9, sharply adjusting the original prediction probability result is called hardening (T<1), and gently adjusting it is called softening (T>1).

According to this embodiment, a softmax temperature is applied to the original prediction probability result ψ′_{i,n} of the individual device 300 based on the local loss value of the individual device to generate a true label approximate value.

At this time, if the local loss value is less than the predetermined threshold, hardening is performed because the original prediction probability result is close to the true label. If the local loss value is greater than the predetermined threshold, softening is performed because the original prediction probability result is far from the true label.

Table 2 defines the parameters used in true label reverse inference using softmax temperature.

TABLE 2

| Notation | Descript |
|---|---|
| T = R^{A} | Softmax temperature |
| L = {I₁, I₂, . . . ] | Loss value set of participating devices |
| R = (1 + (l̅_{i, n} − μ)) | Relative scale |
| ${\overline{l}}_{i , n} = \frac{{l}_{i , n} - min L}{max L - min L}$ | Loss value normalization result |
| μ = mean(L) | Average value of loss value |
| | normalization result |
| A = 1 + u(α − l_{i, n})(l_{i, n} − β)²γ | Absolute scale |
| u(·) | Unit step function |
| α | Boundary that separates meaningful |
| | clients |
| β | Absolute boundary between softening |
| | and hardening |
| γ | Constant value |

Below, the relative scale (R) and absolute scale (A) in true label reverse inference using softmax temperature are explained.

As shown in Table 2, the softmax temperature is determined based on a relative scale and an absolute scale. The relative scale determines the target to be softened or hardened, and the absolute scale refers to the degree of learning.

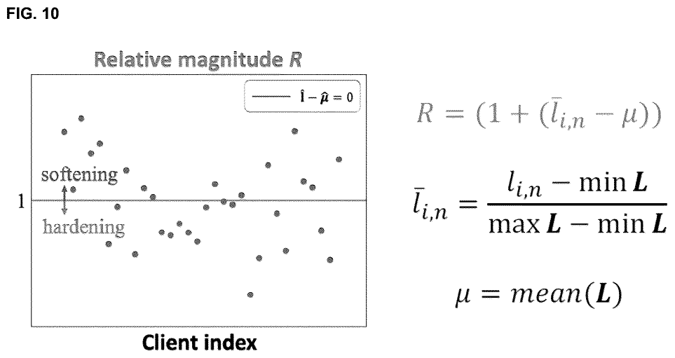

FIG. 10 is a diagram to explain the relative scale in the process using softmax temperature.

The relative scale concerns which individual device's results will be learned more, and is a scale for, in the current communication round, learning more the results of individual devices that are relatively good at predicting and learning less the results of individual devices that are relatively poor at predicting.

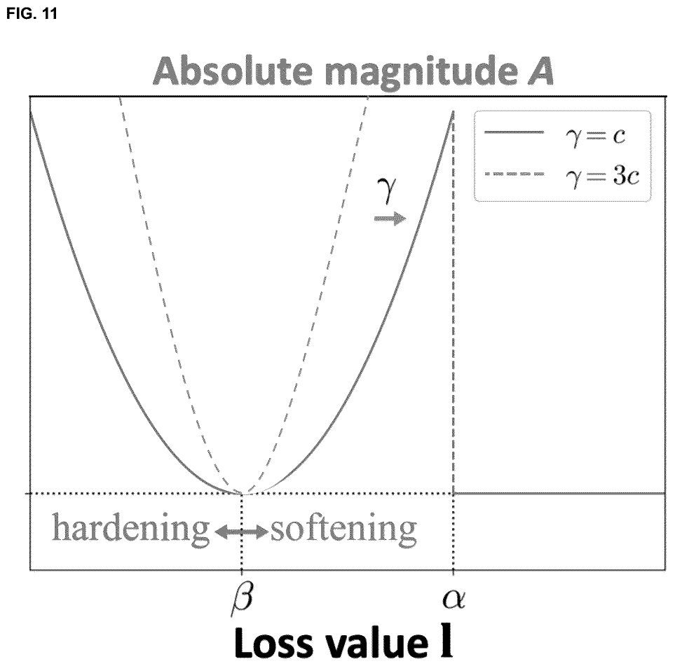

FIG. 11 is a diagram to explain the absolute scale in the process using softmax temperature.

While the above relative scale is to distinguish individual devices that will be learned more/less, the absolute scale is to determine the degree of learning more/less.

According to this embodiment, the learning execution unit 702 performs learning of a large model using a distance-based loss function to follow the distribution of the true label approximate value as shown in Equation 1 in the true label reverse inference using softmax temperature.

Here, the distance-based loss function may be the Kullback-Leibler divergence loss function.

According to another embodiment of the present invention, the true label approximate value generation unit 700 may generate a true label approximate value through a cross-entropy loss-based true label reverse inference method.

Cross entropy loss is a representative loss function for learning a classification model, and the loss value for the true label q_{t,i} is calculated using the prediction value q_{s,i} through the following equation.

$${l}_{i , n} = - {\sum }_{j = 0}^{J} {ψ}_{i , n} ( j ) ln {ψ}_{i , n}^{′} ( j ) = - ln {ψ}_{i , n}^{′} ( {j}^{*} ) \qquad [ Equation 2 ]$$

Here, j* is the true label class.

As in Equation 2, since the local loss value is l_{i,n}=−ln ψ′_{i,n}(j*), the true label probability value can be obtained through exp(−l_{i,n})=ψ′_{i,n}(j*), and the true label approximate value can be generated by using the true label probability value and the elements belonging to the loss value set for the prediction probability result of the global model in the server 302.

Here, there are as many elements belonging to the loss value set as there are classes.

Table 3 is the definition of parameters in the cross entropy loss-based true label inference method.

TABLE 3

| Notation | Descript |
|---|---|
| [symbol] (·) | Loss function |
| ƒ(·,·) | Distance function |
| v_{i,n} | nth latent vector of ith client |
| S | Federated global parameter |

According to this embodiment, the true label approximate value generation unit 700 infers the probability value of the true label through exp(−l_{i,n}) calculation using the loss values l_{i,n} received from a plurality of individual devices 300, and then generates a true label approximate value by predicting the value j* with the minimum distance among the probabilities of global model prediction true labels (loss value set) ψ′_{i,n}(⋅) obtained by inputting local latent vectors into the global model as the true label.

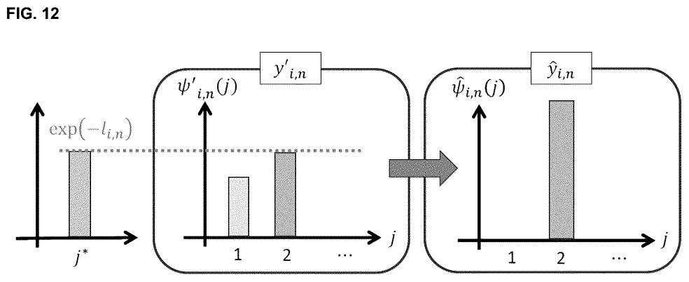

FIG. 12 is a diagram to explain the cross entropy-based true label reverse inference process according to this embodiment.

Since l_{i,n}=−ln ψ′_{i,n}(j*), a true label approximate value of the global model for j* can be generated through exp(−l_{i,n})=ψ′_{i,n}(j*).

That is, by comparing the true label probability value obtained using the loss value l_{i,n} and the prediction probability result (loss value set) of the global model located in the server 302, the element with the closest distance among the elements belonging to the loss value set is generated as a true label approximate value

$${\hat{y}}_{i , n}^{*} = \text{?} f ( {l}_{i , n} , ℒ ( {υ}_{i , n} , \text{?} s ) ) .$$

$$\text{?} \text{indicates text missing or illegible when filed}$$

Here, [symbol] (v_{i,n}, ŷ_{i,n}; s) is the loss value for prediction when the local latent vector v_{i,n} is input to the federated global parameter s (global model) located in the server 302.

According to this embodiment, the value ŷ_{i,n}=[\hat{ψ}_{i,n}(1), . . . , \hat{ψ}_{i,n}(J)] at which the distance f(⋅,⋅) between two loss values is minimum can be used as a true label approximate value.

The learning execution unit 702 according to this embodiment performs learning of a large model using the true label approximate value generated using the cross entropy loss function as described above.

According to this embodiment, generating a true label approximate value and performing learning may be performed for each communication round.

At this time, in order to learn the large model with sufficient data, after generating a true label approximate value and learning the large model in the current communication round, the local latent vector and local loss value transmitted from the individual device 300 in the current communication round are stored in the data storage unit 400.

Thereafter, in the current communication round, the sampling unit 704 randomly samples a portion of the local latent vector and local loss values stored in the previous learning process, that is, the previous communication round.

Generating a true label approximate value and learning a large model are performed once again using the sampled local latent vectors and local loss values.

According to this embodiment, the performance of the large model can be further improved because the learning of the large model is additionally performed through not only the local information received in the current communication round but also past local information.

The above-described knowledge augmenting method using federated learning information can also be implemented in the form of a recording medium containing instructions executable by a computer, such as an application or program module executed by a computer. Computer-readable medium can be any available medium that can be accessed by a computer and includes both volatile and non-volatile medium, removable and non-removable medium. Additionally, computer-readable medium may include computer storage medium. The computer storage medium includes both volatile and non-volatile, removable and non-removable medium implemented in any method or technology for storage of information such as computer-readable instructions, data structures, program modules, or other data.

The above-described knowledge augmenting method using federated learning information may be executed by an application installed by default on the terminal (this may include programs included in the platform or operating system installed by default on the terminal), and may also be executed by an application (i.e., program) installed directly on the master terminal by a user through an application providing server such as an application store server, or a web server related to the application or the service. In this sense, the above-described knowledge augmenting method using federated learning information can be implemented as an application (i.e., program) installed by default in the terminal or directly installed by the user and recorded on a computer-readable recording medium.

The above-described embodiments of the present invention have been disclosed for illustrative purposes, and those skilled in the art will be able to make various modifications, changes, and additions within the spirit and scope of the present invention, and such modifications, changes, and additions should be regarded as falling within the scope of the patent claims below.

1. An apparatus for augmenting knowledge using federated learning information comprising:
a transceiver unit that receives local information including a global parameter of a local model, a local latent vector, and a local loss value from each of a plurality of individual devices;
a data storage unit that stores the local information;
a federated learning execution unit that collects a global parameter of the local model and generates a federated global parameter for a global model; and
a large model learning unit that generates a true label approximate value for learning a large model using the local information and the federated global parameter, and learns the large model using a prediction result obtained by inputting the local latent vector into the large model and the true label approximate value.

2. The apparatus of claim 1, wherein each of the plurality of individual devices uses local data to learn a local model composed of a local parameter and a global parameter,
wherein the local information comprises a global parameter of a local model, in which the learning was performed, a local latent vector obtained by inputting the local data into a local parameter of the local model, and a local loss value obtained by inputting the local latent vector into the global parameter of the local model.

3. The apparatus of claim 1, wherein the large model learning unit comprises,
a true label approximate value generation unit that generates the true label approximate value; and
a learning execution unit that learns the large model using the generated true label approximate value and a preset loss function.

4. The apparatus of claim 3, wherein the true label approximate value generation unit generates the true label approximate value through a softmax temperature-based reverse inference process.

5. The apparatus of claim 4, wherein the true label approximate value generation unit generates a true label approximate value distribution by applying a softmax temperature determined based on the local loss value to a prediction probability result obtained by inputting the local latent vector into the global model.

6. The apparatus of claim 5, wherein the true label approximate value generation unit determines the softmax temperature through a relative scale that allows a lot of learning using local information of an individual device that is relatively good at predicting in a current communication round and an absolute scale that determines an amount of learning using local information of each individual device.

7. The apparatus of claim 5, wherein the learning execution unit performs learning of the large model using a distance-based loss function to follow the true label approximate value distribution.

8. The apparatus of claim 3, wherein the true label approximate value generation unit generates the true label approximate value using a cross-entropy loss function.

9. The apparatus of claim 8, wherein the true label approximate value generation unit generates the true label approximate value using a loss value set for a prediction result obtained by inputting the local latent vector into the global model.

10. The apparatus of claim 9, wherein the true label approximate value generation unit reversely infers an element with the closest distance to a true label probability value as a true label approximate value by using elements included in the loss value set and the true label probability value calculated using the local loss value.

11. The apparatus of claim 1, wherein the large model learning unit,
learns the large model using local information received in a current communication round,
further learns the large model by randomly sampling a portion of the local information stored in the data storage unit.

12. A system for augmenting knowledge using federated learning information comprising:
a plurality of individual devices that store local data for learning a local model composed of a local parameter and a global parameter, learn the local model using the local data, and extract a portion of information about the learned local model as local information; and
a server that receives the extracted local information from each of the plurality of individual devices, stores the local information, generates a federated global parameter for a global model using the local information, uses the local information and the federated global parameter to generate a true label approximate value for learning a large model, and learns the large model using a prediction result obtained by inputting the local latent vector into the large model and the true label approximate value.

13. The system of claim 12, wherein the local information comprises a global parameter of a local model, in which the learning was performed, a local latent vector obtained by inputting the local data into the local parameter of the local model, and a local loss value obtained by inputting the local latent vector into the global parameter of the local model.

14. A method for augmenting knowledge using federated learning information in an apparatus including a processor and a memory comprising:
receiving local information including a global parameter of a local model, a local latent vector, and a local loss value from each of a plurality of individual devices;
storing the local information;
collecting a global parameter of the local model and generating a federated global parameter for a global model using the collected global parameter; and
generating a true label approximate value for learning a large model using the local information, and learning the large model using a prediction result obtained by inputting the local latent vector into the large model and the true label approximate value.

15. A computer program stored in a computer-readable recording medium that performs the method according to claim 14.
